(19) United States
(12) Patent Application Publication
(10) Pub. No.: US 2014/0020534 A1
(43) Pub. Date: Jan. 23, 2014

(54) FINE HYDRO-BLANKING DEVICE

(71) Applicant: Cheng-Ping WANG, Taipei City (TW)

(72) Inventor: Cheng-Ping WANG, Taipei City (TW)

(73) Assignee: NATIONAL TAIWAN OCEAN UNIVERSITY, Keelung City (TW)

(21) Appl. No.: 13/550,889

(22) Filed: Jul. 17, 2012

(51) Int. Cl. B26D 7/01; B23D 31/00

(52) U.S. Cl. 83/169

(57) ABSTRACT

A fine hydro-blanking device is used for blanking a sheet stock. The fine hydro-blanking device includes a clamping module and a punching module. The clamping module is used for clamping the sheet stock. The clamping module includes at least one cavity and at least one fluid flow channel. The at least one fluid flow channel runs through the clamping module. The punching module is inserted into the at least one cavity of the clamping module and contacted with the sheet stock. At least one trough is formed in the sheet stock, and the at least one fluid flow channel is in communication with the at least one trough, so that a liquid is introduced into the at least one trough through the at least one fluid flow channel to provide a liquid pressure to the sheet stock.

### FIELD OF THE INVENTION

The present invention relates to a fine blanking device, and more particularly to a fine hydro-blanking device for increasing the burnish length of the blanked product.

### BACKGROUND OF THE INVENTION

A stamping process (or a press working process) is widely used in many industries such as household goods industries, transportation industries or national defense industries. For example, many parts, daily necessities or cutting tools used in the daily lives are produced by the stamping process. It is estimated that the stamped sheet parts accounts for 59% GDP of the modern automobile industry. That is, the importance of the stamping process is obvious.

The stamping process comprises a variety of sheet-metal forming manufacturing processes. The stamping process is performed by using a stamping machine to apply an external force to a sheet stock. In response to the external force, the sheet stock is correspondingly subject to plastic deformation. The plastic deformation results in shearing, bending and rolling effect in order to produce various kinds of products.

A blanking process is one kind of the stamping process. A conventional blanking device for performing the blanking process has a simple configuration. Generally, the conventional blanking device comprises a punch, a guide plate, and a die. After a sheet stock is punched by the blanking process, the punched-out sheet stock is called as a blank or a blanked product. Since the blanked product has a low percentage of burnish (e.g. about 30˜50% of the thickness of the blanked product) by the conventional blanking process, the blanked product is usually unsatisfied to the manufacturer. Moreover, since the clearance between the punch and the die is large, the precision of the blanked product is relatively low. Moreover, since no counter force is applied to the falling sheet stock (i.e. the blanked product), the blanked product has obvious burr, fracture zone and rollover zone and the length of the burnish is short. For enhancing the quality of the blanked product, the blanked product should be further machined in order to reduce the burr, the fracture zone and the rollover zone and increase the length of the burnish. In other words, the processing steps and the fabricating cost are increased.

For solving the above drawbacks, a fine blanking device has been developed. The operations of the conventional fine blanking device will be illustrated with reference to FIGS. 1, 2 and 3. FIG. 1 is a schematic cross-sectional view illustrating a conventional fine blanking device, in which a sheet stock has not been clamped by the conventional fine blanking device. FIG. 2 is a schematic cross-sectional view illustrating the conventional fine blanking device of FIG. 1, in which the sheet stock is clamped by the conventional fine blanking device. FIG. 3 is a schematic cross-sectional view illustrating the conventional fine blanking device of FIG. 1, in which the sheet stock is clamped by the conventional fine blanking device and the sheet stock is contacted with the punch and the counter punch. Like the conventional blanking device, the conventional fine blanking device also comprises a punch 91, a guide plate 92, and a die 93. In comparison with the conventional blanking device, the conventional fine blanking device further comprises a counter punch 94. During a sheet stock 7 is punched by the punch 91 downwardly, a counter force smaller than the downward force exerted by the punch 91 is applied to the sheet stock 7 upwardly. The use of the counter force may reduce the bending degree of the sheet stock 7. In addition, as shown in FIG. 1, the guide plate 92 further comprises a V-shaped projection ring 92a. Originally, the sheet stock 7 has a flat top surface. When the sheet stock 7 is clamped by the guide plate 92, the top surface of the sheet stock 7 is pressed by the V-shaped projection ring 92a. Consequently, a V-shaped trough 70 is formed in the top surface of the sheet stock 7 at the location corresponding to the V-shaped projection ring 92a, and a hydraulic pressure is applied to the to-be-blanked region of the sheet stock 7. During the to-be-blanked region of the sheet stock 7 is punched by the punch 91, the hydraulic pressure may reduce the fracture zone of the blanked product and increase the length of the burnish. Consequently, the accuracy of the fine blanking process may be enhanced.

However, during the sheet stock 7 is punched by the punch 91, the sheet stock 7 is gradually subject to deformation. Since the profile of the V-shaped projection ring 92a is kept unchanged, the force exerted on the trough 70 is gradually non-uniformly distributed as time varies. Correspondingly, the hydraulic pressure applied to the to-be-blanked region of the sheet stock 7 is uniformly changed. Under this circumstance, the burr, the fracture zone and the rollover zone are still obvious and need to be further reduced. Moreover, the length of the burnish of the blanked product is still unsatisfactory.

Moreover, since the V-shaped projection ring 92a of the conventional fine blanking device 9 needs to frequently press the sheet stock 7, the V-shaped projection ring 92a becomes structurally weak. That is, the V-shaped projection ring 92a is readily damaged, and the life span may only provide several thousands of fine blanking cycles to at most several ten thousand times of fine blanking cycles. Under this circumstance, the cost of replacing the fine blanking device is increased.

Moreover, due to the special structure, the V-shaped projection ring 92a is only suitable to punch out the thin sheet stock with a thickness smaller than 1 centimeter. That is, the V-shaped projection ring 92a is not feasible to punch out the thick sheet stock. Moreover, the conventional fine blanking device 9 is not feasible to punch out a large-sized sheet stock as a large-sized blanked product (e.g. a blanked product with a diameter of at least 3 centimeters). If the conventional fine blanking device 9 is employed to punch out a large area of the sheet stock, the thickness of the sheet stock should be as thin as possible. Under this circumstance, the bending degree of the blanked product becomes more obvious. In other words, the applications of the sheet stock 7 in the conventional fine blanking device are highly restricted.

Moreover, although the length of the burnish of the blanked product is increased by the conventional by the fine blanking process, there are still some drawbacks. For example, if the profile of the blanked product (e.g. a gear) is relatively complicated, the burnish of the blanked product is not uniformly distributed. In other words, the quality of the complicated blanked product produced by the conventional fine blanking process is still unsatisfactory to the manufacturer. Moreover, although the V-shaped projection ring 92a can increase the length of the burnish of the blanked product, the fabricating cost of the fine blanking device 9 is increased.

Therefore, there is a need of providing an improved fine blanking device in order to reduce the possibility of bending the blanked product, increase the length of the burnish of the blanked product and reduce the fabricating cost. Moreover, the fine blanking device is feasible to punch thick sheet stocks or large-sized sheet stock and fabricate the complicated blanked product (e.g. precision gears).

### SUMMARY OF THE INVENTION

The present invention provides a fine hydro-blanking device for blanking a sheet stock. The fine hydro-blanking device has a fluid flow channel in communication with a trough of the sheet stock. During the sheet stock is punched by the fine hydro-blanking device, a liquid pressure is applied to the sheet stock to generate a hydraulic pressure. Consequently, the length of the burnish of the blanked product is increased. In addition, the fine hydro-blanking device is feasible to fabricate blanked products with complicated profiles.

In accordance with an aspect of the present invention, there is provided a fine hydro-blanking device for blanking a sheet stock. The fine hydro-blanking device includes a clamping module and a punching module. The clamping module is used for clamping the sheet stock. The clamping module includes at least one cavity and at least one fluid flow channel. The at least one fluid flow channel runs through the clamping module. The punching module is inserted into the at least one cavity of the clamping module and contacted with the sheet stock. At least one non-V-shaped trough is formed in the sheet stock, and the at least one fluid flow channel is in communication with the at least one non-V-shaped trough, so that a liquid is introduced into the at least one non-V-shaped trough through the at least one fluid flow channel to provide a liquid pressure to the sheet stock.

In an embodiment, the at least one non-V-shaped trough is formed in a top surface of the sheet stock and in communication with the at least one fluid flow channel. Alternatively, the at least one non-V-shaped trough is formed in a bottom surface of the sheet stock and in communication with the at least one fluid flow channel. Alternatively, the at least one non-V-shaped trough includes two non-V-shaped troughs, the at least one fluid flow channel includes two fluid flow channels, and the two non-V-shaped troughs are respectively formed on a top surface and a bottom surface of the sheet stock and in communication with the two fluid flow channels.

In an embodiment, the fine hydro-blanking device further includes a sealing means. The sealing means is arranged between the sheet stock and the clamping module and/or arranged between the clamping module and the punching module.

In an embodiment, the pushing module includes a punch. The punch is inserted into the cavity and directly contacted with the sheet stock.

In an embodiment, the fluid flow channel is in communication with the cavity, and the liquid is introduced into the cavity through the fluid flow channel to be contacted with a bottom surface of the sheet stock. Alternatively, the punching module further includes a counter punch, and the counter punch is directly contacted with the sheet stock. Alternatively, the punching module further includes a counter punch, the fluid flow channel is in communication with the cavity, the liquid is introduced into the cavity through the fluid flow channel to be contacted with a bottom surface of the sheet stock, and the liquid is compressed by the counter punch so as to apply a counter force to the sheet stock.

In an embodiment, the non-V-shaped trough is a U-shaped trough or a trapezoid trough.

In accordance with another aspect of the present invention, there is provided a fine hydro-blanking device for blanking a sheet stock. The fine hydro-blanking device includes a clamping module, a punching module, and a sealing means. The clamping module is used for clamping the sheet stock. The clamping module includes at least one cavity and at least one fluid flow channel. The at least one fluid flow channel runs through the clamping module. The punching module is inserted into the at least one cavity of the clamping module and contacted with the sheet stock. The sealing means is arranged between the sheet stock and the clamping module. At least one trough is formed in the sheet stock, and the at least one fluid flow channel is in communication with the at least one trough, so that a liquid is introduced into the at least one trough through the at least one fluid flow channel to provide a liquid pressure to the sheet stock.

In an embodiment, the at least one trough is formed in a top surface of the sheet stock and in communication with the at least one fluid flow channel. Alternatively, the at least one trough is formed in a bottom surface of the sheet stock and in communication with the at least one fluid flow channel. Alternatively, the at least one trough includes two troughs, the at least one fluid flow channel includes two fluid flow channels, and the two troughs are respectively formed on a top surface and a bottom surface of the sheet stock and in communication with the two fluid flow channels.

In an embodiment, the sealing means is further arranged between the clamping module and the punching module.

In an embodiment, the pushing module includes a punch. The punch is inserted into the cavity and directly contacted with the sheet stock.

In an embodiment, the fluid flow channel is in communication with the cavity, and the liquid is introduced into the cavity through the fluid flow channel to be contacted with a bottom surface of the sheet stock. Alternatively, the punching module further includes a counter punch, and the counter punch is directly contacted with the sheet stock. Alternatively, the punching module further includes a counter punch, the fluid flow channel is in communication with the cavity, the liquid is introduced into the cavity through the fluid flow channel to be contacted with a bottom surface of the sheet stock, and the liquid is compressed by the counter punch so as to apply a counter force to the sheet stock.

In an embodiment, the trough is a V-shaped trough, a U-shaped trough or a trapezoid trough.

In accordance with a further aspect of the present invention, there is provided a fine hydro-blanking device for blanking a sheet stock. The fine hydro-blanking device includes a clamping module and a punching module. The clamping module is used for clamping the sheet stock. The clamping module includes at least one cavity and at least one fluid flow channel. The at least one fluid flow channel runs through the clamping module. The punching module is inserted into the at least one cavity of the clamping module and contacted with the sheet stock. At least one trough is formed in the sheet stock. A contour line of a cross section of the at least one trough matches a contour line of a cross section of the punching module and is longer than the contour line of the cross section of the punching module. The at least one fluid flow channel is in communication with the at least one trough, so that a liquid is introduced into the at least one trough through the at least one fluid flow channel to provide a liquid pressure to the sheet stock.

In an embodiment, the at least one trough is formed in a top surface of the sheet stock and in communication with the at least one fluid flow channel. Alternatively, the at least one trough is formed in a bottom surface of the sheet stock and in communication with the at least one fluid flow channel. Alternatively, the at least one trough includes two troughs, the at least one fluid flow channel includes two fluid flow channels, and the two troughs are respectively formed on a top surface and a bottom surface of the sheet stock and in communication with the two fluid flow channels.

In an embodiment, the fine hydro-blanking device further includes a sealing means. The sealing means is arranged between the sheet stock and the clamping module and/or arranged between the clamping module and the punching module.

In an embodiment, the pushing module includes a punch. The punch is inserted into the cavity and directly contacted with the sheet stock.

In an embodiment, the fluid flow channel is in communication with the cavity, and the liquid is introduced into the cavity through the fluid flow channel to be contacted with a bottom surface of the sheet stock. Alternatively, the punching module further includes a counter punch, and the counter punch is directly contacted with the sheet stock. Alternatively, the punching module further includes a counter punch, the fluid flow channel is in communication with the cavity, the liquid is introduced into the cavity through the fluid flow channel to be contacted with a bottom surface of the sheet stock, and the liquid is compressed by the counter punch so as to apply a counter force to the sheet stock.

In an embodiment, the trough is a V-shaped trough, a U-shaped trough or a trapezoid trough.

In accordance with a still aspect of the present invention, there is provided a fine hydro-blanking device for blanking a sheet stock. The fine hydro-blanking device includes a clamping module and a punching module. The clamping module is used for clamping the sheet stock. The clamping module includes at least one cavity and at least one fluid flow channel. The at least one fluid flow channel runs through the clamping module. The punching module is inserted into the at least one cavity of the clamping module and contacted with the sheet stock. At least one trough is formed in the sheet stock, and the at least one fluid flow channel is in communication with the at least one trough, so that a liquid is introduced into the at least one trough through the at least one fluid flow channel to provide a liquid pressure to the sheet stock.

In an embodiment, the at least one trough is formed in a top surface of the sheet stock and in communication with the at least one fluid flow channel. Alternatively, the at least one trough is formed in a bottom surface of the sheet stock and in communication with the at least one fluid flow channel. Alternatively, the at least one trough includes two troughs, the at least one fluid flow channel includes two fluid flow channels, and the two are respectively formed on a top surface and a bottom surface of the sheet stock and in communication with the two fluid flow channels.

In an embodiment, the fine hydro-blanking device further includes a sealing means. The sealing means is arranged between the sheet stock and the clamping module and/or arranged between the clamping module and the punching module.

In an embodiment, the pushing module includes a punch. The punch is inserted into the cavity and directly contacted with the sheet stock.

In an embodiment, the fluid flow channel is in communication with the cavity, and the liquid is introduced into the cavity through the fluid flow channel to be contacted with a bottom surface of the sheet stock. Alternatively, the punching module further includes a counter punch, and the counter punch is directly contacted with the sheet stock. Alternatively, the punching module further includes a counter punch, the fluid flow channel is in communication with the cavity, the liquid is introduced into the cavity through the fluid flow channel to be contacted with a bottom surface of the sheet stock, and the liquid is compressed by the counter punch so as to apply a counter force to the sheet stock.

In an embodiment, the trough is a V-shaped trough, a U-shaped trough or a trapezoid trough.

In an embodiment, a contour line of a cross section of the at least one trough matches a contour line of a cross section of the punching module and is longer than the contour line of the cross section of the punching module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a conventional fine blanking device, in which a sheet stock has not been clamped by the conventional fine blanking device;

FIG. 2 is a schematic cross-sectional view illustrating the conventional fine blanking device of FIG. 1, in which the sheet stock is clamped by the conventional fine blanking device;

FIG. 3 is a schematic cross-sectional view illustrating the conventional fine blanking device of FIG. 1, in which the sheet stock is clamped by the conventional fine blanking device and the sheet stock is contacted with the punch and the counter punch;

FIG. 4 is a schematic cutaway view illustrating a fine hydro-blanking device according to a first embodiment of the present invention, in which a trough is formed in a top surface of a sheet stock;

FIG. 5 is a schematic enlarged fragmentary view illustrating the circumscribed zone A of the fine hydro-blanking device as shown in FIG. 4;

FIG. 6 is a schematic cross-sectional view illustrating the fine hydro-blanking device according to the first embodiment of the present invention, in which the U-shaped trough is formed in the top surface of the sheet stock;

FIG. 7 is a schematic cross-sectional view illustrating the fine hydro-blanking device according to the first embodiment of the present invention, in which a U-shaped trough is formed in the bottom surface of the sheet stock;

FIG. 8 is a schematic cross-sectional view illustrating the fine hydro-blanking device according to the first embodiment of the present invention, in which two U-shaped troughs are respectively formed in the top surface and the bottom surface of the sheet stock;

FIG. 9 is a schematic cross-sectional view illustrating a fine hydro-blanking device according to a second embodiment of the present invention, in which a trapezoid trough is formed in the top surface of the sheet stock;

FIG. 10 is a schematic cross-sectional view illustrating the fine hydro-blanking device according to the second embodiment of the present invention, in which a trapezoid trough is formed in the bottom surface of the sheet stock;

FIG. 11 is a schematic cross-sectional view illustrating the fine hydro-blanking device according to the second embodiment of the present invention, in which two trapezoid troughs are respectively formed in the top surface and the bottom surface of the sheet stock;

FIG. 12 is a schematic cross-sectional view illustrating a fine hydro-blanking device according to a third embodiment of the present invention, in which a V-shaped trough is formed in the top surface of the sheet stock;

FIG. 13 is a schematic cross-sectional view illustrating the fine hydro-blanking device according to the third embodiment of the present invention, in which a V-shaped trough is formed in the bottom surface of the sheet stock;

FIG. 14 is a schematic cross-sectional view illustrating the fine hydro-blanking device according to the second embodiment of the present invention, in which two V-shaped troughs are respectively formed in the top surface and the bottom surface of the sheet stock;

FIG. 15 is a schematic cross-sectional view illustrating a fine hydro-blanking device according to a fourth embodiment of the present invention, in which a sheet stock has not been clamped by the conventional fine blanking device;

FIG. 16 is a schematic cross-sectional view illustrating the fine hydro-blanking device of FIG. 15, in which the sheet stock is clamped by the conventional fine blanking device;

FIG. 17 is a schematic cross-sectional view illustrating the conventional fine blanking device, in which the sheet stock is clamped by the fine hydro-blanking device of FIG. 15 and the sheet stock is contacted with the punch and the counter punch;

FIG. 18 is a schematic top view illustrating an exemplary sheet stock to be punched by the fine hydro-blanking device; and

FIG. 19 is a schematic top view illustrating another exemplary sheet stock to be punched by the fine hydro-blanking device.

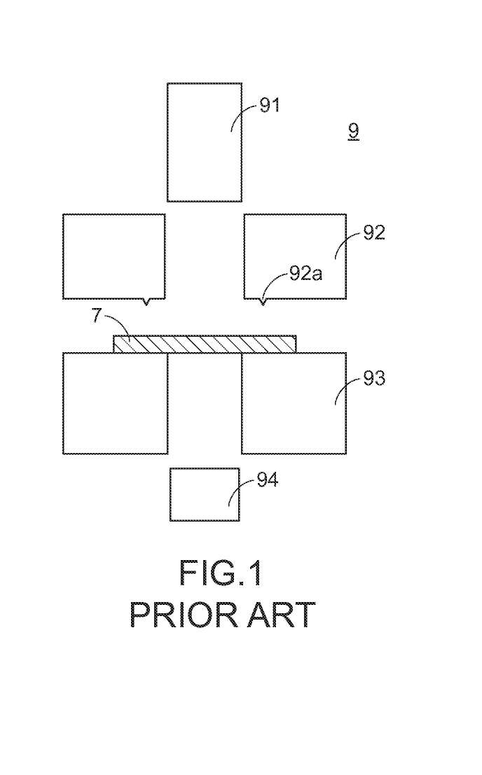

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown. For well understanding the present invention, the elements shown in the drawings are not in scale with the elements of the practical product.

The present invention provides a fine hydro-blanking device. The fine hydro-blanking device has a fluid flow channel for accommodating a liquid and a trough directly formed in a sheet stock in order to replace the function of the V-shaped projection ring of the conventional fine blanking device. Moreover, during a sheet stock is punched by the fine hydro-blanking device of the present invention, a liquid pressure (also referred as a hydraulic pressure) is applied to the trough of the sheet stock in order to prevent from movement of the sheet stock. Consequently, the burnish percentage of the blanked product and the quality of the blanked product are not adversely affected. The stamping process performed by the fine hydro-blanking device is similar to the conventional stamping process, and is not redundantly described herein.

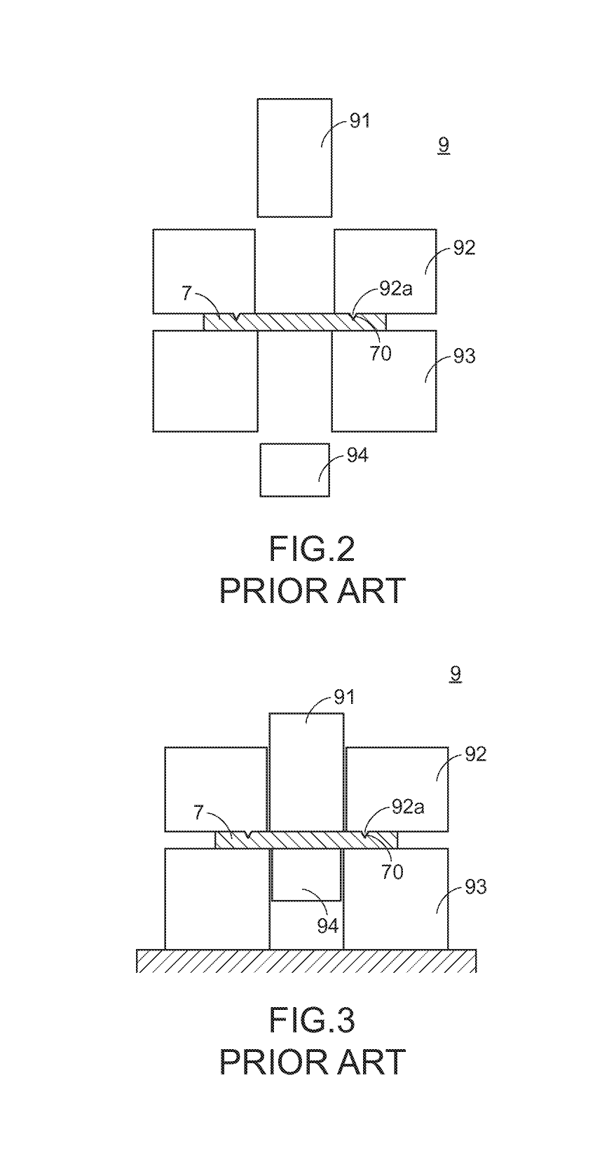

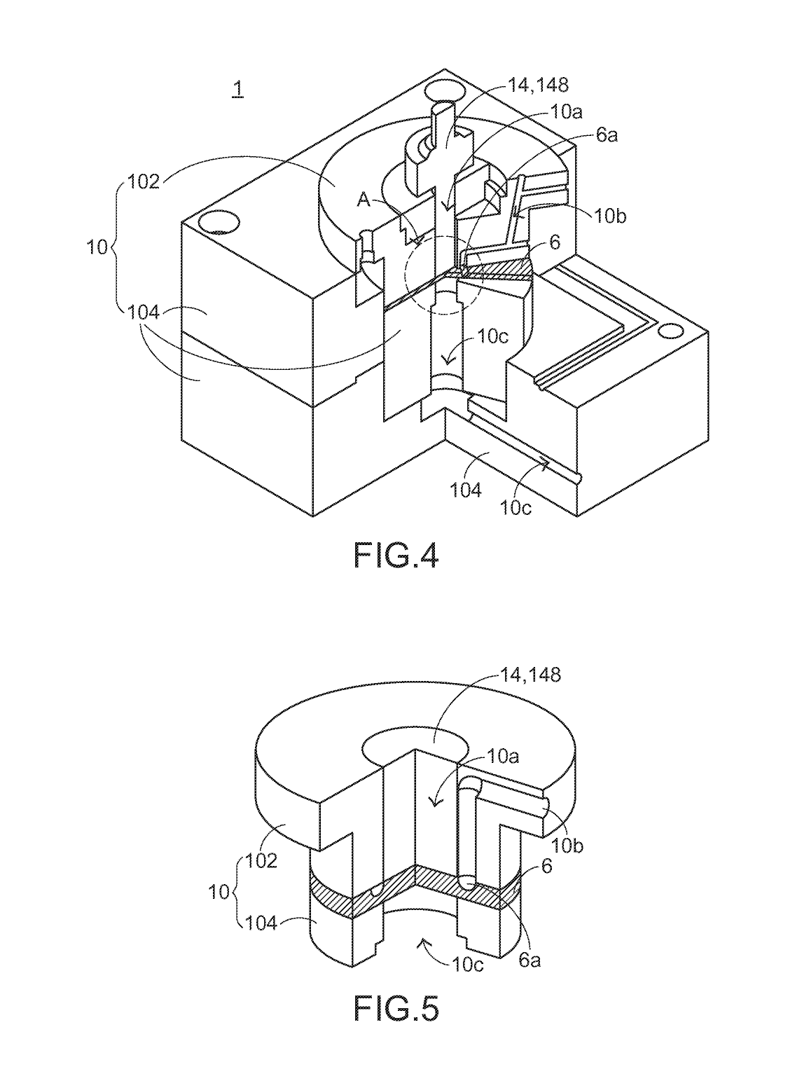

FIG. 4 is a schematic cutaway view illustrating a fine hydro-blanking device according to a first embodiment of the present invention, in which a U-shaped trough is formed in a top surface of a sheet stock. FIG. 5 is a schematic enlarged fragmentary view illustrating the circumscribed zone A of the fine hydro-blanking device as shown in FIG. 2.

In accordance with a feature of the present invention, a trough may be previously formed in the top surface of the sheet stock by a simple machining process (e.g. using a milling cutter). Depending on the shape of the cross section of the trough, the trough of the sheet stock may be classified into a V-shaped trough and a non-V-shaped trough. For example, the non-V-shaped trough is a U-shaped trough, a trapezoid trough or any other trough with non-V-shaped cross section. In this embodiment, the trough with a U-shaped cross section (i.e. a U-shaped trough) is presented herein for purpose of illustration and description only. Nevertheless, the trough may be a V-shaped trough or a trapezoid trough.

Please refer to FIGS. 4 and 5 again. The fine hydro-blanking device 1 comprises a clamping module 10 and a punching module 14. The clamping module 10 comprises a guide plate 102 and a die 104. A sheet stock 6 is clamped between the guide plate 102 and the die 104. The clamping module 10 comprises at least one cavity 10a and at least one fluid flow channel 10b. The at least one fluid flow channel 10b runs through the clamping module 10. In this embodiment, at least one trough 6a is formed in a top surface of the sheet stock 6. The at least one fluid flow channel 10b of the clamping module 10 is in communication with the trough 6a of the sheet stock 6. A liquid may be introduced into the trough 6a of the sheet stock 6 through the fluid flow channel 10b so as to provide a liquid pressure (also referred as a hydraulic pressure) to the surface of the trough 6a.

Moreover, the punching module 14 comprises a punch 148. The punch 148 is inserted into the cavity 10a of the clamping module 10 and directly contacted with the sheet stock 6. In this embodiment, the clamping module 10 comprises two fluid flow channels 10b and 10c. The fluid flow channel 10b is disposed within the guide plate 102 and in communication with the trough 6a. The fluid flow channel 10c is disposed within the die 104 and directly contacted with a bottom surface of the sheet stock 6. Since the liquid from the fluid flow channel 10c provides a uniform liquid pressure to the sheet stock 6, during the sheet stock 6 is punched by the punch 148, the bending degree of the blanked product will be alleviated.

Moreover, the trough 6a of the sheet stock 6 may be previously formed by a simple and convenient machining process (e.g. using a milling cutter) before the blanking process is performed. Moreover, the trough 6a of the sheet stock 6 is no longer restricted by the single depth of the V-shaped projection ring of the conventional fine blanking device. Moreover, the thickness or profile of the sheet stock 6 and the area of the blanked product are not restricted. In a case that the fine hydro-blanking device of the present invention is employed to finely blank the sheet stock 6, the thickness of the sheet stock 6 may be at least 1 centimeter, and the diameter of the blanked product may be at least 3 centimeters.

It is noted that the thickness of the sheet stock 6 and the diameter of the blanked product are presented herein for purpose of illustration and description only. For example, the thickness or the area of the sheet stock 6 may be higher. Of course, the fine hydro-blanking device of the present invention may be employed to produce the blanked product with smaller area or thinner thickness, and the quality of the blanked product is better than that obtained by conventional fine blanking device.

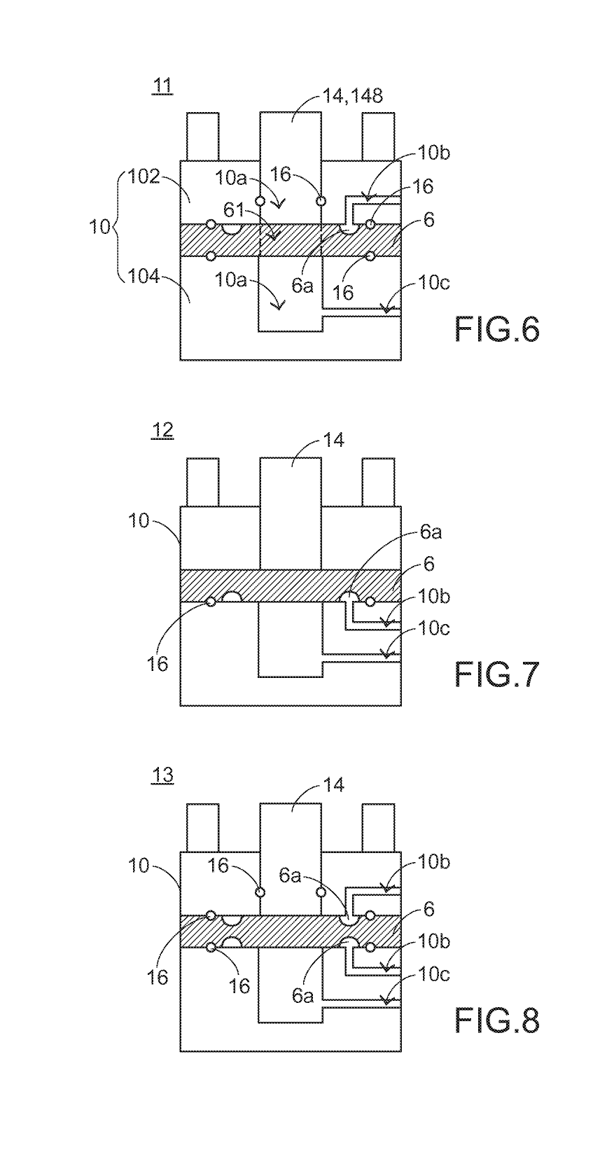

FIG. 6 is a schematic cross-sectional view illustrating the fine hydro-blanking device according to the first embodiment of the present invention, in which a U-shaped trough is formed in the top surface of the sheet stock. FIG. 7 is a schematic cross-sectional view illustrating the fine hydro-blanking device according to the first embodiment of the present invention, in which a U-shaped trough is formed in the bottom surface of the sheet stock. FIG. 8 is a schematic cross-sectional view illustrating the fine hydro-blanking device according to the first embodiment of the present invention, in which two U-shaped troughs are respectively formed in the top surface and the bottom surface of the sheet stock.

For punching the sheet stock 6, the user may press down the punch 148, so that the punch 148 is moved toward the sheet stock 6. After the punch 148 is contacted with the sheet stock 6, the punch 148 is continuously pressed down to punch out the sheet stock 6 as a blanked product 61 (see FIG. 6). Then, the blanked product 61 is separated from the sheet stock 6. Since the blanked product 61 is punched out from the sheet stock 6 by the punch 148, the contour of the edge cutting surface of the blanked product 61 is determined according to the contour of the cross section of the punch 148. In this embodiment, during the punch 148 is moved back, the liquid pressure within the cavity 10a is simultaneously increased. Consequently, the blanked product 61 is pushed upwardly from the cavity 10a and then ejected out.

Please refer to FIGS. 6, 7 and 8. As shown in FIG. 6, the trough 6a is formed in the top surface of the sheet stock 6. It is noted that the location of the trough 6a may be varied according to the practical requirements. For example, as shown in FIG. 7, the trough 6a may be formed in the bottom surface of the sheet stock 6 and in communication with the fluid flow channel 10b. Alternatively, as shown in FIG. 8, two troughs 6a are respectively formed in the top surface and the bottom surface of the sheet stock 6 and in communication with the two fluid flow channels 10b. From the above discussions, the fine hydro-blanking devices 11, 12 and 13 are possible variant examples of the fine hydro-blanking device according to the first embodiment of the present invention. Moreover, in order to permit fluid communication between the trough 6a and the fluid flow channel 10b, the location of the fluid flow channel 10b of the clamping module 10 may be varied according to the location of the trough 6a (see FIGS. 7 and 8)

Moreover, each of the fine hydro-blanking devices 11, 12 and 13 further comprises a sealing means 16. The sealing means 16 is arranged between the sheet stock 6 and the clamping module 10. Alternatively, the sealing means 16 is arranged between the clamping module 10 and the punching module 14. Due to the sealing means 16, the liquid within the fluid flow channel 10b and the trough 6a will not be leaked out from the gap between the sheet stock 6 and the clamping module 10 or from the gap between the clamping module 10 and the punching module 14.

Preferably, the sealing means 16 includes but is not limited to an O-ring, two gears which are engaged with each other, a gluing means, an oil-sealing means or any other sealing means.

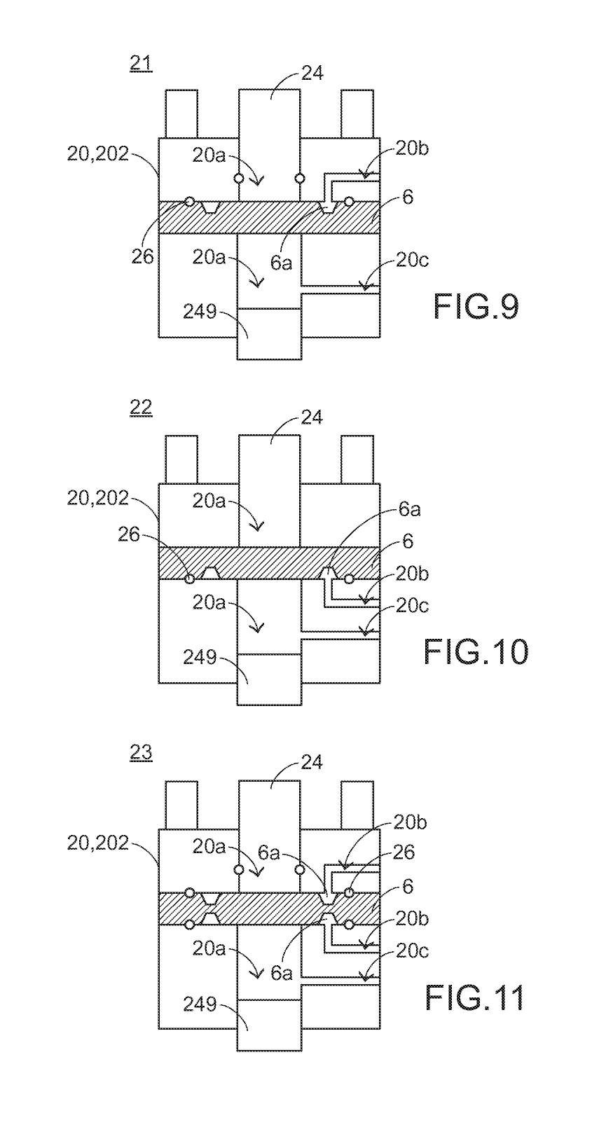

FIG. 9 is a schematic cross-sectional view illustrating a fine hydro-blanking device according to a second embodiment of the present invention, in which a trapezoid trough is formed in the top surface of the sheet stock. FIG. 10 is a schematic cross-sectional view illustrating the fine hydro-blanking device according to the second embodiment of the present invention, in which a trapezoid trough is formed in the bottom surface of the sheet stock. FIG. 11 is a schematic cross-sectional view illustrating the fine hydro-blanking device according to the second embodiment of the present invention, in which two trapezoid troughs are respectively formed in the top surface and the bottom surface of the sheet stock.

Please refer to FIGS. 9, 10 and 11. Similar to the first embodiment, each of the fine hydro-blanking devices 21, 22 and 23 comprises a clamping module 20 and a punching module 24. The clamping module 20 is used for blanking a sheet stock 6. Moreover, the clamping module 20 comprises at least one cavity 20a and at least one fluid flow channel 20b. The at least one fluid flow channel 20b runs through the clamping module 20. In this embodiment, at least one trough 6a is formed in a surface of the sheet stock 6. The at least one fluid flow channel 20b of the clamping module 20 is in communication with the trough 6a of the sheet stock 6. The clamping module 20 comprises two fluid flow channels 20b and 20c. The fluid flow channel 20b is disposed within the guide plate 202 of the clamping module 20 and in communication with the trough 6a. The fluid flow channel 20c is in communication with the cavity 20a. The liquid is introduced into the cavity 20a through the fluid flow channel 20c and contacted with the bottom surface of the sheet stock 6. The at least one trough 6a may be formed in the top surface, the bottom surface or any other location of the sheet stock 6. Moreover, the number of the at least one trough 6a is not restricted. Moreover, each of the fine hydro-blanking devices 21, 22 and 23 further comprises a sealing means 26 and other structures. The sealing means 26 and other structures are similar to those of the first embodiment, and are not redundantly described herein.

In comparison with the first embodiment, the punching module 24 of the fine hydro-blanking device of the second embodiment further comprises a counter plate 249. The counter plate 249 is inserted into the cavity 20a. By applying a counter force to the counter plate 249, the liquid within the cavity 20a is pushed upwardly. After the blanked product is punched out from the sheet stock 6, the liquid may be compressed by the counter plate 249 in order to facilitate ejecting out the blanked product. Moreover, in this embodiment, the trough 6a is a trapezoid trough.

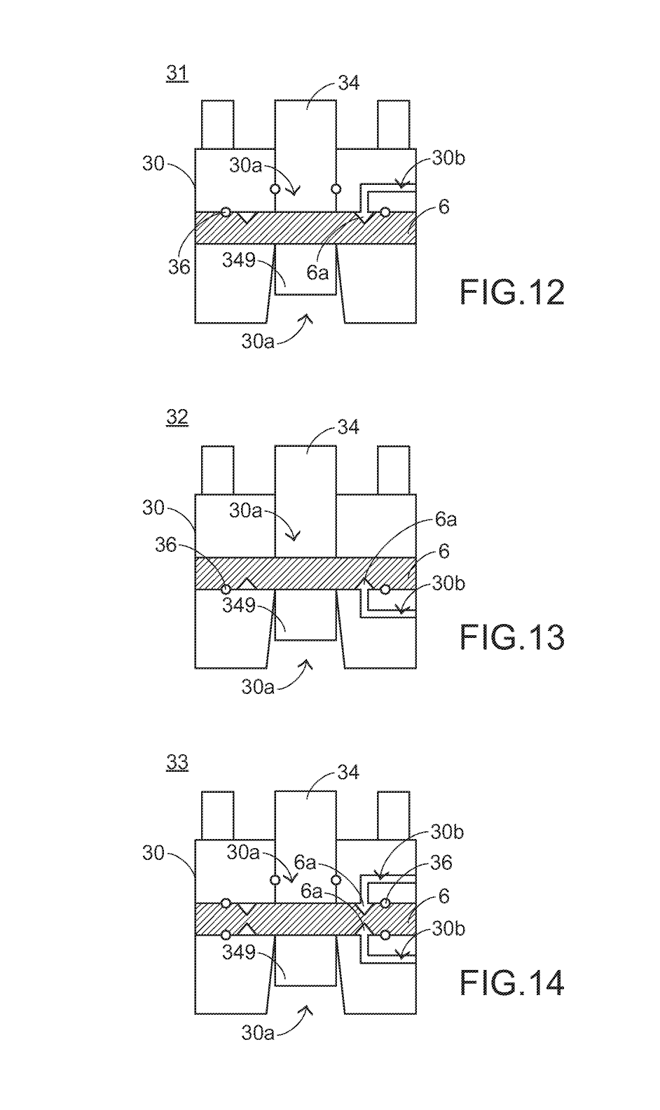

FIG. 12 is a schematic cross-sectional view illustrating a fine hydro-blanking device according to a third embodiment of the present invention, in which a V-shaped trough is formed in the top surface of the sheet stock. FIG. 13 is a schematic cross-sectional view illustrating the fine hydro-blanking device according to the third embodiment of the present invention, in which a V-shaped trough is formed in the bottom surface of the sheet stock. FIG. 14 is a schematic cross-sectional view illustrating the fine hydro-blanking device according to the second embodiment of the present invention, in which two V-shaped troughs are respectively formed in the top surface and the bottom surface of the sheet stock.

Please refer to FIGS. 12, 13 and 14. Similar to the first and second embodiments, each of the fine hydro-blanking devices 31, 32 and 33 comprises a clamping module 30 and a punching module 34. The clamping module 30 is used for blanking a sheet stock 6. Moreover, the clamping module 30 comprises at least one cavity 30a and at least one fluid flow channel 30b. The at least one fluid flow channel 30b runs through the clamping module 30. In this embodiment, at least one trough 6a is formed in a surface of the sheet stock 6. The at least one fluid flow channel 30b of the clamping module 30 is in communication with the trough 6a of the sheet stock 6. Moreover, each of the fine hydro-blanking devices 31, 32 and 33 further comprises a sealing means 36 and other structures. The sealing means 36 and other structures are similar to those of the first and second embodiments, and are not redundantly described herein.

In comparison with the first and second embodiments, the clamping module 30 of the fine hydro-blanking device of the third embodiment only comprises the fluid flow channel 30b, which is in communication with the trough 6a. Moreover, in comparison with the first and second embodiments, no fluid flow channel is in communication with the cavity 30a. Moreover, the punching module 34 of the fine hydro-blanking device of the third embodiment further comprises a counter plate 349. The counter plate 349 is inserted into the cavity 30a. By applying a counter force to the counter plate 349, the sheet stock 6 is pushed upwardly. After the blanked product is punched out from the sheet stock 6, the blanked product may be ejected out by the counter plate 349. Moreover, the cavity 30a for accommodating the counter plate 349 has a non-uniform inner diameter, which is gradually increased along the direction distant from the sheet stock 6. Moreover, in this embodiment, the trough 6a is a V-shaped trough.

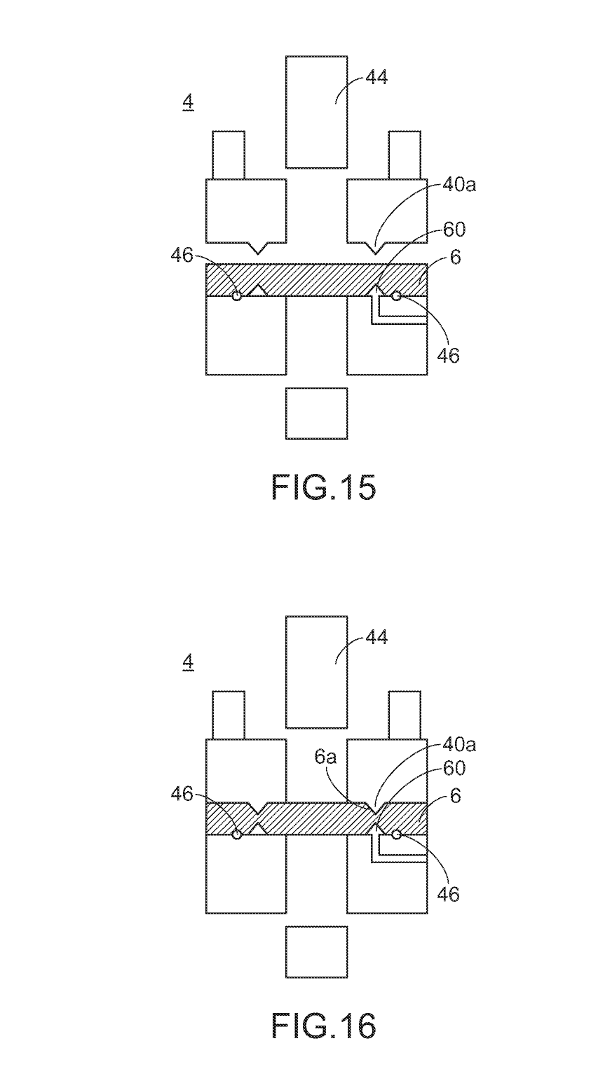

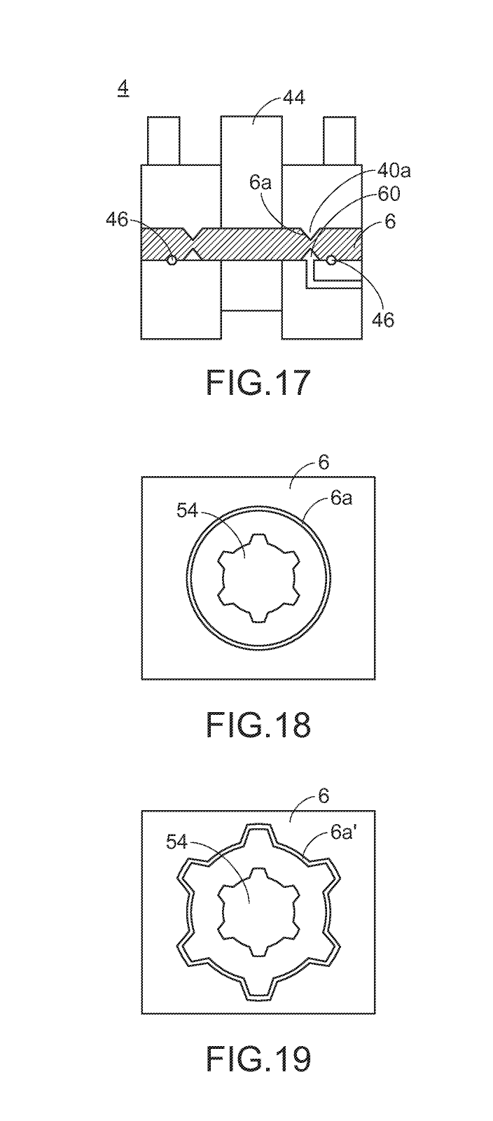

FIG. 15 is a schematic cross-sectional view illustrating a fine hydro-blanking device according to a fourth embodiment of the present invention, in which a sheet stock has not been clamped by the conventional fine blanking device. FIG. 16 is a schematic cross-sectional view illustrating the fine hydro-blanking device of FIG. 15, in which the sheet stock is clamped by the conventional fine blanking device. FIG. 17 is a schematic cross-sectional view illustrating the conventional fine blanking device, in which the sheet stock is clamped by the fine hydro-blanking device of FIG. 15 and the sheet stock is contacted with the punch and the counter punch. As shown in FIGS. 15, 16 and 17, the clamping module of the fine hydro-blanking device 4 further comprises a V-shaped projection ring 40a. When the sheet stock 6 is clamped by the clamping module, the top surface of the sheet stock 6 is pressed by the V-shaped projection ring 40a. Consequently, a V-shaped trough 60 is formed in the top surface of the sheet stock 6 at the location corresponding to the V-shaped projection ring 40a, and a hydraulic pressure is applied to the to-be-blanked region of the sheet stock 6. Moreover, another trough 6a is previously formed in the bottom surface of the sheet stock 6 by a simple machining process. A liquid may be introduced into the trough 6a of the sheet stock 6 to provide a liquid pressure (also referred as a hydraulic pressure) to the sheet stock 6. In other words, the fine hydro-blanking device 4 incorporates the concepts of the above embodiments with the concept of the conventional fine blanking device.

Moreover, the fine hydro-blanking device 4 further comprises a sealing means 46. The sealing means 46 is similar to that of the first and second embodiments, and is not redundantly described herein.

FIG. 18 is a schematic top view illustrating an exemplary sheet stock to be punched by the fine hydro-blanking device. As shown in FIG. 18, the contour line of the cross section of the punching module 54 is enclosed by the contour line of the cross section of the trough 6a of the sheet stock 6. Through the trough 6a, a liquid pressure may be applied to the to-be-blanked region of the sheet stock 6 (not shown), which is located under the punching module 54.

Certainly, the contour line of the cross section of the trough 6a aforementioned may be a regular or irregular geometric contour line, it should not be restricted herein.

Moreover preferably, please refer to FIG. 19. FIG. 19 is a schematic top view illustrating another exemplary sheet stock to be punched by the fine hydro-blanking device. In this embodiment, the contour line of the cross section of the trough 6a′ of the sheet stock 6 is correlated with the contour line of the cross section of the punching module 54. Moreover, the contour line of the cross section of the trough 6a′ of the sheet stock 6 is slightly longer than the contour line of the cross section of the punching module 54. Through the trough 6a, a liquid pressure may be uniformly applied to the to-be-blanked region of the sheet stock 6 (not shown), which is located under the punching module 54. Consequently, during the sheet stock 6 is punched by the fine hydro-blanking device, the shear stress applied on the blanked product is distributed more uniformly. Under this circumstance, the length of the burnish of the blanked product is increased.

Of course, the trough 6a′ with the special profile may be previously formed on the sheet stock 6 by a simple and convenient machining process (e.g. using a milling cutter). Consequently, the fine hydro-blanking device may be used to fabricate blanked products with complicated profiles in a cost-effective manner.

From the above description, the present invention provides a fine hydro-blanking device for blanking a sheet stock. The fine hydro-blanking device has a fluid flow channel in communication with a trough of the sheet stock. A liquid is introduced into the trough of the sheet stock through the fluid flow channel to provide a liquid pressure to the sheet stock. The fine hydro-blanking device of the present invention is suitable to fabricate thick blanked products (e.g. the blanked products with a thickness of at least 1 centimeter) and large-sized blanked products (e.g. the blanked products with a diameter of at least 3 centimeters). Moreover, the fine hydro-blanking device may be used to fabricate blanked products with complicated profiles in a cost-effective and simple manner. Moreover, since the fine hydro-blanking device of the present invention applies the liquid pressure to the sheet stock, the possibility of damaging the fine hydro-blanking device is reduced and the cost of replacing the fine hydro-blanking device is largely reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A fine hydro-blanking device for blanking a sheet stock, said fine hydro-blanking device comprising:
a clamping module for clamping said sheet stock, wherein said clamping module comprises at least one cavity and at least one fluid flow channel, and said at least one fluid flow channel runs through said clamping module; and
a punching module inserted into said at least one cavity of said clamping module and contacted with said sheet stock,
wherein at least one non-V-shaped trough is formed in said sheet stock, and said at least one fluid flow channel is in communication with said at least one non-V-shaped trough, so that a liquid is introduced into said at least one non-V-shaped trough through said at least one fluid flow channel to provide a liquid pressure to said sheet stock.

2. The fine hydro-blanking device according to claim 1, wherein said at least one non-V-shaped trough is formed in a top surface of said sheet stock and in communication with said at least one fluid flow channel, or wherein said at least one non-V-shaped trough is formed in a bottom surface of said sheet stock and in communication with said at least one fluid flow channel, or wherein said at least one non-V-shaped trough comprises two non-V-shaped troughs, said at least one fluid flow channel comprises two fluid flow channels, and said two non-V-shaped troughs are respectively formed on a top surface and a bottom surface of said sheet stock and in communication with said two fluid flow channels.

3. The fine hydro-blanking device according to claim 2, further comprising a sealing means, wherein said sealing means is arranged between said sheet stock and said clamping module and/or arranged between said clamping module and said punching module.

4. The fine hydro-blanking device according to claim 3, wherein said pushing module comprises a punch, wherein said punch is inserted into said cavity and directly contacted with said sheet stock.

5. The fine hydro-blanking device according to claim 4, wherein said fluid flow channel is in communication with said cavity, and said liquid is introduced into said cavity through said fluid flow channel to be contacted with a bottom surface of said sheet stock, or wherein said punching module further comprises a counter punch, and said counter punch is directly contacted with said sheet stock, or wherein said punching module further comprises a counter punch, said fluid flow channel is in communication with said cavity, said liquid is introduced into said cavity through said fluid flow channel to be contacted with a bottom surface of said sheet stock, and said liquid is compressed by said counter punch so as to apply a counter force to said sheet stock.

6. The fine hydro-blanking device according to claim 1, wherein the non-V-shaped trough is a U-shaped trough or a trapezoid trough.

7. A fine hydro-blanking device for blanking a sheet stock, said fine hydro-blanking device comprising:
a clamping module for clamping said sheet stock, wherein said clamping module comprises at least one cavity and at least one fluid flow channel, and said at least one fluid flow channel runs through said clamping module;
a punching module inserted into said at least one cavity of said clamping module and contacted with said sheet stock; and
a sealing means arranged between said sheet stock and said clamping module,
wherein at least one trough is formed in said sheet stock, and said at least one fluid flow channel is in communication with said at least one trough, so that a liquid is introduced into said at least one trough through said at least one fluid flow channel to provide a liquid pressure to said sheet stock.

8. The fine hydro-blanking device according to claim 7, wherein said at least one trough is formed in a top surface of said sheet stock and in communication with said at least one fluid flow channel, or wherein said at least one trough is formed in a bottom surface of said sheet stock and in communication with said at least one fluid flow channel, or wherein said at least one trough comprises two troughs, said at least one fluid flow channel comprises two fluid flow channels, and said two troughs are respectively formed on a top surface and a bottom surface of said sheet stock and in communication with said two fluid flow channels.

9. The fine hydro-blanking device according to claim 8, wherein said sealing means is further arranged between said clamping module and said punching module.

10. The fine hydro-blanking device according to claim 9, wherein said pushing module comprises a punch, wherein said punch is inserted into said cavity and directly contacted with said sheet stock.

11. The fine hydro-blanking device according to claim 10, wherein said fluid flow channel is in communication with said cavity, and said liquid is introduced into said cavity through said fluid flow channel to be contacted with a bottom surface of said sheet stock, or wherein said punching module further comprises a counter punch, and said counter punch is directly contacted with said sheet stock, or wherein said punching module further comprises a counter punch, said fluid flow channel is in communication with said cavity, said liquid is introduced into said cavity through said fluid flow channel to be contacted with a bottom surface of said sheet stock, and said liquid is compressed by said counter punch so as to apply a counter force to said sheet stock.

12. The fine hydro-blanking device according to claim 7, wherein the trough is a V-shaped trough, a U-shaped trough or a trapezoid trough.

13. A fine hydro-blanking device for blanking a sheet stock, said fine hydro-blanking device comprising:
a clamping module for clamping said sheet stock, wherein said clamping module comprises at least one cavity and at least one fluid flow channel, and said at least one fluid flow channel runs through said clamping module; and
a punching module inserted into said at least one cavity of said clamping module and contacted with said sheet stock,
wherein at least one trough is formed in said sheet stock, and a contour line of a cross section of said at least one trough matches a contour line of a cross section of said punching module and is longer than said contour line of said cross section of said punching module, wherein said at least one fluid flow channel is in communication with said at least one trough, so that a liquid is introduced into said at least one trough through said at least one fluid flow channel to provide a liquid pressure to said sheet stock.

14. The fine hydro-blanking device according to claim 13, wherein said at least one trough is formed in a top surface of said sheet stock and in communication with said at least one fluid flow channel, or wherein said at least one trough is formed in a bottom surface of said sheet stock and in communication with said at least one fluid flow channel, or wherein said at least one trough comprises two troughs, said at least one fluid flow channel comprises two fluid flow channels, and said two troughs are respectively formed on a top surface and a bottom surface of said sheet stock and in communication with said two fluid flow channels.

15. The fine hydro-blanking device according to claim 14, further comprising a sealing means, wherein said sealing means is arranged between said sheet stock and said clamping module and/or arranged between said clamping module and said punching module.

16. The fine hydro-blanking device according to claim 15, wherein said pushing module comprises a punch, wherein said punch is inserted into said cavity and directly contacted with said sheet stock.

17. The fine hydro-blanking device according to claim 16, wherein said fluid flow channel is in communication with said cavity, and said liquid is introduced into said cavity through said fluid flow channel to be contacted with a bottom surface of said sheet stock, or wherein said punching module further comprises a counter punch, and said counter punch is directly contacted with said sheet stock, or wherein said punching module further comprises a counter punch, said fluid flow channel is in communication with said cavity, said liquid is introduced into said cavity through said fluid flow channel to be contacted with a bottom surface of said sheet stock, and said liquid is compressed by said counter punch so as to apply a counter force to said sheet stock.

18. The fine hydro-blanking device according to claim 13, wherein the trough is a V-shaped trough, a U-shaped trough or a trapezoid trough.

19. A fine hydro-blanking device for blanking a sheet stock, said fine hydro-blanking device comprising:
a clamping module for clamping said sheet stock, wherein said clamping module comprises at least one cavity and at least one fluid flow channel, and said at least one fluid flow channel runs through said clamping module; and
a punching module inserted into said at least one cavity of said clamping module and contacted with said sheet stock,
wherein at least one trough is formed in said sheet stock, and said at least one fluid flow channel is in communication with said at least one trough, so that a liquid is introduced into said at least one trough through said at least one fluid flow channel to provide a liquid pressure to said sheet stock.

20. The fine hydro-blanking device according to claim 19, wherein said at least one trough is formed in a top surface of said sheet stock and in communication with said at least one fluid flow channel, or wherein said at least one trough is formed in a bottom surface of said sheet stock and in communication with said at least one fluid flow channel, or wherein said at least one trough comprises two troughs, said at least one fluid flow channel comprises two fluid flow channels, and said two troughs are respectively formed on a top surface and a bottom surface of said sheet stock and in communication with said two fluid flow channels.

21. The fine hydro-blanking device according to claim 20, further comprising a sealing means, wherein said sealing means is arranged between said sheet stock and said clamping module and/or arranged between said clamping module and said punching module.

22. The fine hydro-blanking device according to claim 21, wherein said pushing module comprises a punch, wherein said punch is inserted into said cavity and directly contacted with said sheet stock.

23. The fine hydro-blanking device according to claim 22, wherein s said fluid flow channel is in communication with said cavity, and said liquid is introduced into said cavity through said fluid flow channel to be contacted with a bottom surface of said sheet stock, or wherein said punching module further comprises a counter punch, and said counter punch is directly contacted with said sheet stock, or wherein said punching module further comprises a counter punch, said fluid flow channel is in communication with said cavity, said liquid is introduced into said cavity through said fluid flow channel to be contacted with a bottom surface of said sheet stock, and said liquid is compressed by said counter punch so as to apply a counter force to said sheet stock.

24. The fine hydro-blanking device according to claim 19, wherein the trough is a V-shaped trough, a U-shaped trough or a trapezoid trough.

25. The fine hydro-blanking device according to claim 19, wherein a contour line of a cross section of said at least one trough matches a contour line of a cross section of said punching module and is longer than said contour line of said cross section of said punching module.
